(19) United States
(12) Patent Application Publication
(10) Pub. No.: US 2026/0127036 A1
(43) Pub. Date: May 7, 2026

(54) AN ARITHMETIC AVERAGE-BASED SCALING SYSTEM AND AN OPERATION METHOD THEREOF

(71) Applicant: BTS KURUMSAL BILISIM TEKNOLOJILERI ANONIM SIRKETI, Atasehir/Istanbul (TR)

(72) Inventors: Özgür PALANTÖKEN, Pendik/Istanbul (TR); Khayal HUSEYNOV, Sisli/Istanbul (TR); Dogukan ÇELIK, Çankaya/Ankara (TR); Osman Alper ÖZCAN, Sariyer/Istanbul (TR); Gökhan YURDAKUL, Üsküdar/Istanbul (TR)

(21) Appl. No.: 19/116,352

(22) PCT Filed: Dec. 29, 2023
(86) PCT No.: PCT/TR2023/051869

§ 371 Date: Mar. 27, 2025

(30) Foreign Application Priority Data
Dec. 20, 2023 (TR) 2023/017838

(51) Int. Cl. G06F 9/50; G06F 9/455; G06F 9/48

(52) U.S. Cl. CPC G06F 9/505; G06F 9/45558; G06F 9/4881; G06F 2009/45562

(57) ABSTRACT

The invention relates to an arithmetic average-based and computer-aided scaling system with at least one processor and an operation method thereof. In the system of the invention, both the virtual machines and the containers are scaled in the same group, which ensures a more efficient and balanced use of the resources. The system of the invention enables the scaling operations to be performed in the local infrastructure, and thus the users have the opportunity to scale outside the cloud and gain more flexibility in terms of security and control. In the system of the invention, the minimization of resource and power waste is achieved by the ability to automate the operations of distributing and managing the workloads of the virtual machines and containers running on the physical servers and the clustered mediums such as network and storage through the components deployed on the physical servers.

### TECHNICAL FIELD OF THE INVENTION

The invention relates to an arithmetic average-based and computer-aided scaling system with at least one processor and an operation method thereof.

### STATE OF THE ART

Machine learning (ML) is a subset of the artificial intelligence (Al) that focuses on building the systems that learn or improve the performance based on the data they consume. In the state of the art, when the machine learning methods or statistical methods are used, the differences between the current scales of the variables cause the algorithms used to cause inaccuracies in the evaluation phase of the variables. Therefore, said variables are scaled in order to prevent the errors that may occur during the evaluation phase.

In the state of the art, a cloud-based predictive automatic scaling algorithm has the ability to automatically increase or decrease the virtual server instances based on the user-specified scaling policies, workloads, and resource usage. The software-based data center algorithm provides the automatic scaling of resources using the machine learning algorithms. This algorithm predicts the future requests by analyzing the past usage patterns, and thus the scaling policies are determined based on the requirements determined by the user. These policies determine the scaling triggers and when the automatic scaling operations start. In the cloud, the applications and services can be automatically scaled based on the workloads, and when necessary, new instances can be automatically created or the number of the existing instances can be increased. Some software products request some of their components to be served on the virtual machine during the installation phase, and the others to be served as the virtualized medium at the operating system level. In addition, in the process of obtaining a service by using different software products together, some of the software used may be software that can only run on a virtual machine, and some may run only in a container. The algorithms in the state of the art do not scale both the virtual server instances and the container groups simultaneously. This makes them incapable of scaling only the component or software batch that has too much workload in the mentioned installation scenarios, and causes the components that do not need scaling to be included in the scope of scaling.

Due to the reasons such as the fact that the algorithms used in arithmetic average-based scaling systems in the state of the art cannot scale both virtual server instances and container groups at the same time, and this causes difficulties in effective scaling for certain workloads, it has become necessary to introduce an arithmetic average-based scaling system that eliminates all these problems.

### SUMMARY AND OBJECTS OF THE INVENTION

The invention describes an arithmetic average-based and computer-aided scaling system with at least one processor and an operation method thereof. In the system of the invention, both the virtual machines and the containers are scaled in the same group, which ensures a more efficient and balanced use of the resources. The system of the invention enables the scaling operations to be performed in the local infrastructure, and thus the users have the opportunity to scale outside the cloud and gain more flexibility in terms of security and control. In the system of the invention: computation, the minimization of resource and power waste is achieved by the ability to automate the operations of distributing and managing the workloads of the virtual machines and containers running on the physical servers and the clustered mediums such as computation, network and storage through the components deployed on the physical servers.

The object of the invention is to provide an arithmetic average-based and computer-aided scaling system with at least one processor and an operation method thereof, which can scale both the virtual server instances and container groups simultaneously, enabling effective scaling for the specific workloads. In the system of the invention, the groups that can host both the virtual machines and containers are created by the user. When creating these groups, the parameters are received regarding when they should be copied and when their number should be reduced. Both the containers and virtual machines can be hosted in the same group. Here it is the group itself that is copied and reduced in number (i.e., scaled). When a group hosting two virtual machines and three containers is copied, a second group is created, and within this group, two more virtual machines and three containers cloned from the first copied group are created. In the system of the invention, both the virtual machines and the containers are scaled in the same group, which ensures a more efficient and balanced use of the resources. In addition, thanks to the option for the automatic release of the unnecessary resources, when the workload decreases or becomes balanced, the resources that are no longer needed are given back, preventing the unnecessary resource usage. In the system of the invention, the user can apply a scaling strategy customized to the workload and requirements of the application by determining the scaling and copying conditions of the groups. The system of the invention enables the scaling operations to be performed in the local infrastructure, and thus the users have the opportunity to scale outside the cloud and gain more flexibility in terms of security and control. This offers the users the ability to scale the workloads as needed and manage the resources more effectively.

In the invention, in an arithmetic average-based and computer-aided scaling system with at least one processor, the resource and power waste is minimized by ensuring that the server resources are used flexibly according to the requests. In the system of the invention, the minimization of resource and power waste is achieved by the ability to automate the operations of distributing and managing the workloads of the virtual machines and containers running on the physical servers and the clustered mediums such as computation, network and storage through the components deployed on the physical servers.

### DESCRIPTION OF THE DRAWINGS

FIG. 1 shows a hierarchical view of the components scaled in the system of the invention on the physical server.

FIG. 2 shows a schematic representation of the operation method of the system of the invention.

FIG. 3 shows the hierarchical view of the components of the inventive system, wherein A: configuration, B: storage and C: computation.

FIG. 4 shows the views of the system of the invention before and after scaling, wherein D: the elastic clone group is cloned and scaled when it exceeds the specified maximum load ratio, wherein A: configuration, B: storage, and C: computation.

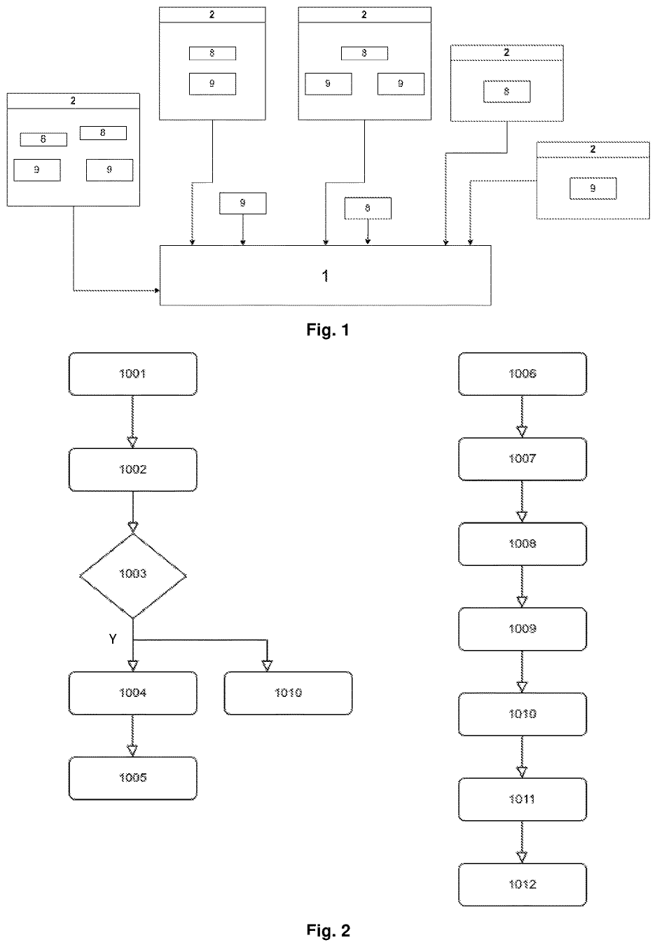

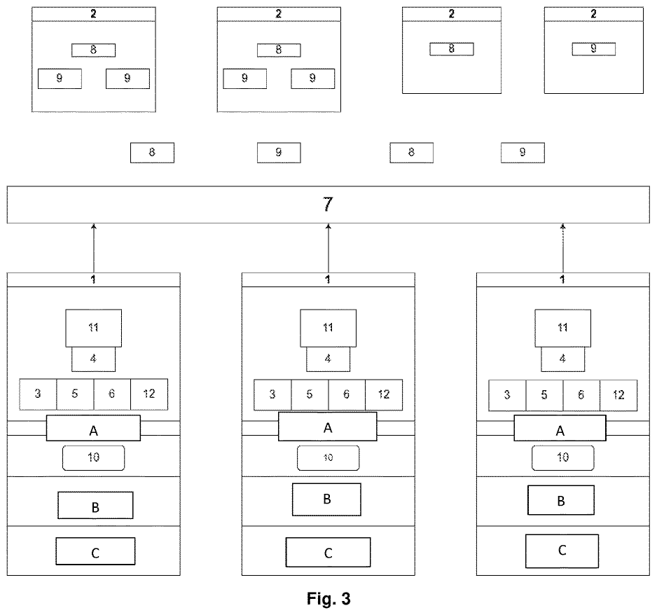

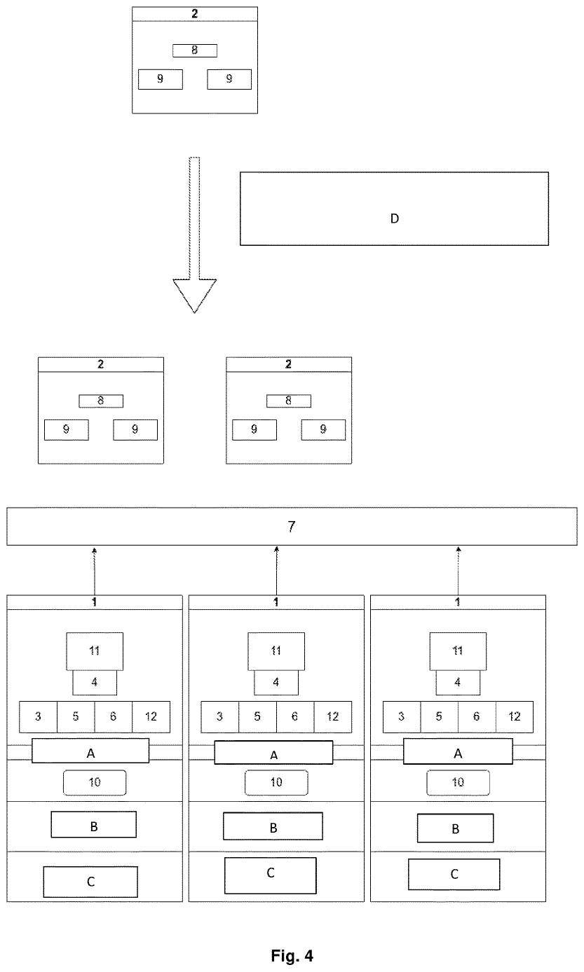

### DESCRIPTION OF THE REFERENCES IN DRAWINGS

1. Physical server
2. Elastic clone group
3. Controller service module
4. Application programming interface
5. Distributed key-value store module
6. Elastic clone group controller module
7. Cluster module
8. Container
9. Virtual machine
10. Operating system
11. User interface
12. Storage controller module
1001. Creating, by the user, the new elastic clone groups (2) via the user interface (11) and transmitting, by the user interface (11), this request to the application programming interface (4)
1002. Checking, by the application programming interface (4), the feasibility of the user request
1003. If the request is appropriate, creating the operation and transferring the operations/objects to the distributed key-value store module (5)
1004. Detecting, by the controller service module (3), the operations coming to the distributed key-value store module (5)
1005. Checking, by the controller service module (3), which server will perform the operation and performing the relevant operation
1006. Activating the controller service module (3) when the arithmetic average limits specified for the clone scaling are exceeded or when the user requests to scale the clone
1007. Checking, by the elastic clone group controller module (6), the limits of the physical servers and the applicability of the configuration policies when cloning is performed
1008. Transmitting, by the elastic clone group controller module (6), the results to the distributed key-value store module (5)
1009. Collecting and monitoring, by the elastic clone group controller module, the resource usage information of the physical servers (1), virtual machines (9) and containers (8)
1010. Controlling, by the distributed key-value store module (5), the metadata on the physical server (1) and providing the data sharing between the servers
1011. Checking, by the storage service, the operability of the storage controller module (12) and controlling the operations that can be performed on the disks
1012. Reading, by the user interface (11), the change in the load of the clones from the distributed key-value store module (5) via the application programming interface (4) and displaying it to the user and if the usage decreases, sending a notification to the user and removing, by the user, the unnecessary clones

### DETAILED DESCRIPTION OF THE INVENTION

The invention relates to an arithmetic average-based and computer-aided scaling system with at least one processor and an operation method thereof. In the system of the invention, both the virtual machines and the containers are scaled in the same group, which ensures a more efficient and balanced use of the resources. The system of the invention enables the scaling operations to be performed in the local infrastructure, and thus the users have the opportunity to scale outside the cloud and gain more flexibility in terms of security and control. In the system of the invention, the minimization of resource and power waste is achieved by the ability to automate the operations of distributing and managing the workloads of the virtual machines (9) and containers (8) running on the physical servers (1) and the clustered mediums such as computation, network and storage through the components deployed on the physical servers (1).

An arithmetic average-based and computer-aided scaling system of the invention with at least one processor comprises
a physical server (1), which is the physical hardware server on which the system components run, manages the hardware resources and hosts the workloads,
an elastic clone group (2) that performs logical grouping and resource sharing of different types of the virtualized objects
a controller service module (3), which is responsible for the hardware management of the physical server (1) and exchanges information with the neighboring physical servers in the cluster of which the physical server (1) is a member,
an application programming interface (4) that is responsible for receiving the user requests and initiating the operations
a distributed key-value store module (5) that performs consistent data sharing and is responsible for controlling the metadata on the physical server (1) and checking the operability of the servers,
an elastic clone group controller module (6), which is responsible for managing the cloning operations, controlling the limits of the physical servers and controlling the configuration policies,
a cluster module (7), which represents the structure in which the physical and virtual servers are brought together and is responsible for distributing the workloads and ensuring the efficient operation,
a container (8) that enables the applications to be run in isolation from each other in the operating system,
a virtual machine (9) that enables running more than one operating system on the physical server with the virtualization technology,
an operating system (10), which is responsible for accessing the software programs running on the hardware and managing the operations, manages the system resources and enables the operating medium,
a user interface (11) that gives the end user the functionality to manage the appearance and features in the system, and
a storage controller module (12) on each physical server (1), which checks the health of the storage areas hosting all data and manages the storage areas.

An operation method of an arithmetic average-based and computer-aided scaling system of the invention with at least one processor comprises the process steps of
i. creating, by the user, the new elastic clone groups via the user interface (11) (1001),
ii. checking, by the application programming interface (4), the feasibility of the user request to create an elastic clone group(1002),
iii. creating the operation if the virtual machine (9) and containers (8) within the scope of the request exist, and transferring the operations/objects to the distributed key-value store module (5) (1003),
iv. detecting, by the controller service module (3), the operations coming to the distributed key-value store module (5) (1004),
v. checking, by the controller service module (3), which server will perform the operation and recording the logical grouping, referred to as the elastic clone group (2), to the distributed key-value store module (5) (1005),
vi. activating the controller service module (3) when the arithmetic average usage limits specified for the clone scaling are exceeded or when the user requests to create the clone (1006),
vii. checking, by the elastic clone group controller module (6), the limits of the physical servers and the applicability of the configuration policies when cloning is performed (1007),
viii. transmitting, by the elastic clone group controller module (6), the results to the distributed key-value store module (5) (1008),
ix. collecting and monitoring, by the elastic clone group controller module (6), the resource usage information of the physical servers (1), virtual machines (9) and containers (8) (1009),
x. checking, by the distributed key-value store module (5), the metadata on the physical server (1) and providing the data sharing between the servers (1010),
xi. checking, by the storage controller module (12), the operability of the storage units and controlling the operations that can be performed on the disks (1011),
xii. sending a notification about a decrease in the load of the clones to the user and removing, by the user, the unnecessary clones (1012).

In an arithmetic average-based and computer-aided scaling system of the invention with at least one processor, the resource and power waste is minimized by ensuring that the server resources are used flexibly according to the requests. In the system of the invention, the minimization of resource and power waste is achieved by the ability to automate the operations of distributing and managing the workloads of the virtual machines (9) and containers (8) running on the physical servers (1) and the clustered mediums such as computation, network and storage through the components deployed on the physical servers (1).

The physical servers (1), virtual machines (9) running with different operating systems (10) on the physical servers (1) and containers (8) constitute the basic building blocks of a network, hardware and storage clustering medium. On these servers, there are the elastic clone groups (2) created by the users. The elastic clone group controller module (6) provides the logical grouping of different types of the virtualized objects. When creating these groups, the factors such as scaling prerequisites and other configuration policies are taken into account, along with the determination of the certain criteria such as the maximum operating resource limit.

Each physical server (1) has its own controller service module (3). Said controller service module (3) is responsible for the physical server (1) on which it is located and exchanges information with other servers. The processor within the application programming interface (4) and cluster module (7) controller services create an operation based on the incoming request and determine which server's controller service module (3) will perform this operation. In this way, the efficient operation is achieved by ensuring a coordination between the servers.

When the necessary conditions for creating a clone are met or when the user requests to create a clone, the controller service module (3) is activated. The user designs the new elastic clone groups (2) via the user interface (11). In this case, the user's request is transmitted to the application programming interface (4). The application programming interface (4) checks the feasibility of this request and the adequacy of the resources. If the request is appropriate, the operation is created and the operations/objects are transferred to the distributed key-value store module (5). The controller service module (3) constantly checks the distributed key-value store module (5) to detect the request and takes the necessary actions when it detects an operation assigned thereto. The distributed key-value store module (5) checks the metadata on the physical server on which it is installed and whether the requirements such as the metadata being accessible on the cluster module (7) are met, and checks whether the servers in the cluster module (7) are operable or not. If there is no problem, it checks the operability of the storage areas of the storage controller module (12) and checks whether there are any problems in the operations that can be performed on the disks and how much of the disks are used. The elastic clone group controller module (6) checks the limit of the physical servers while the cloning is performed, checks whether there are enough resources and verification units, and checks the applicability of the configuration policies and decides to create a clone. At the same time, the elastic clone group controller module (6) transmits the results to the distributed key-value store module (5), so that all physical servers (1) can communicate with each other. The elastic clone group controller module (6) is a component collecting and monitoring the resource usage information of the physical servers (1), virtual machines (9) and containers (8). The collected resource usage information is synchronized with other physical servers (1) using the distributed key-value store module (5). The synchronization process is performed using a specially designed algorithm [1] to ensure a consistent data replication in the distributed systems. Said algorithm is used to ensure the data consistency between the servers in the system and to enable sharing of current data.

After new clones are created, the load is shared between the elastic clone group controller modules, thus ensuring more efficient use of the resources. When the load decreases, a notification is sent to the user and the unnecessary clones are removed by the user. This operation is not performed automatically as it may cause the user data loss.

### REFERENCES

[1] D. Ongaro and J. Ousterhout, “In search of an understandable consensus algorithm,” in Proceedings of the 2014 USENIX conference on USENIX Annual Technical Conference (USENIX ATC'14). USENIX Association, USA, 2014, p. 305-320.

1. An arithmetic average-based and computer-aided scaling system with at least one processor, wherein it comprises
a physical server (1), which is the physical hardware server on which the system components run, manages the hardware resources and hosts the workloads,
an elastic clone group (2) that performs logical grouping and resource sharing of different types of the virtualized objects
a controller service module (3), which is responsible for the hardware management of the physical server (1) and exchanges information with the neighboring physical servers in the cluster of which the physical server (1) is a member,
an application programming interface (4) that is responsible for receiving the user requests and initiating the operations
a distributed key-value store module (5) that performs consistent data sharing and is responsible for checking the metadata on the physical server (1) and checking the operability of the servers,
an elastic clone group controller module (6), which is responsible for managing the cloning operations, checking the limits of the physical servers and checking the configuration policies,
a cluster module (7), which represents the structure in which the physical and virtual servers are brought together and is responsible for distributing the workloads and ensuring the efficient operation,
a container (8) that enables the applications to be run in isolation from each other in the operating system,
a virtual machine (9) that enables running more than one operating system on the physical server with the virtualization technology,
an operating system (10), which is responsible for accessing the software programs running on the hardware and managing the operations, manages the system resources and enables the operating medium,
a user interface (11) that gives the end user the functionality to manage the appearance and features in the system, and
a storage controller module (12) on each physical server (1), which controls the health of the storage areas hosting all data and manages the storage areas.

2. An operation method of an arithmetic average-based and computer-aided scaling system with at least one processor, wherein it comprises the process steps of
i. creating, by the user, the new elastic clone groups via the user interface (11) (1001),
ii. checking, by the application programming interface (4), the feasibility of the user request to create an elastic clone group(1002),
iii. creating the operation if the virtual machine (9) and containers (8) within the scope of the request exist, and transferring the operations/objects to the distributed key-value store module (5) (1003),
iv. detecting, by the controller service module (3), the operations coming to the distributed key-value store module (5) (1004),
v. checking, by the controller service module (3), which server will perform the operation and recording the logical grouping, referred to as the elastic clone group (2), to the distributed key-value store module (5) (1005),
vi. activating the controller service module (3) when the arithmetic average usage limits specified for the clone scaling are exceeded or when the user requests to create the clone (1006),
vii. checking, by the elastic clone group controller module (6), the limits of the physical servers and the applicability of the configuration policies when cloning is performed (1007),
viii. transmitting, by the elastic clone group controller module (6), the results to the distributed key-value store module (5) (1008),
ix. collecting and monitoring, by the elastic clone group controller module (6), the resource usage information of the physical servers (1), virtual machines (9) and containers (8) (1009),
x. checking, by the distributed key-value store module (5), the metadata on the physical server (1) and providing the data sharing between the servers (1010),
xi. checking, by the storage controller module (12), the operability of the storage units and checking the operations that can be performed on the disks (1011),
xii. sending a notification about a decrease in the load of the clones to the user and removing, by the user, the unnecessary clones (1012).
